(19) United States
(12) Patent Application Publication
(10) Pub. No.: US 2008/0001100 A1
(43) Pub. Date: Jan. 3, 2008

(54) Apparatus for inspecting a substrate having a ring illumination unit

(76) Inventor: Gi-Bok Son, Gyeonggi-do (KR)

Correspondence Address: MYERS BIGEL SIBLEY & SAJOVEC, PO BOX 37428, RALEIGH, NC, 27627, US

(21) Appl. No.: 11/787,299

(22) Filed: Apr. 16, 2007

(30) Foreign Application Priority Data
May 3, 2006 (KR) 2006-39848

(51) Int. Cl. G01N 21/00

(52) U.S. Cl. 250/492.1

(57) ABSTRACT

An apparatus for inspecting a substrate includes a stage configured to support a substrate having an inspection region and an image acquisition unit configured to acquire an image of the inspection region to inspect the inspection region. A ring illumination unit is between the stage and the image acquisition unit and is configured to illuminate the inspection region. The ring illumination unit includes a printed circuit board having a ring-shaped inner surface facing toward the inspection region and a plurality of light-emitting elements circumferentially mounted on the ring-shaped inner surface.

### CROSS-REFERENCE TO RELATED APPLICATIONS

This application claims priority under 35 USC § 119 to Korean Patent Application No. 2006-39848 filed on May 3, 2006, the contents of which are incorporated herein by reference in their entirety.

### BACKGROUND OF THE INVENTION

1. Field of the Invention

The present invention relates generally to microelectronics fabrication, and more particularly, to an apparatus for inspecting a substrate.

2. Description of the Related Art

Semiconductor devices are typically manufactured by repeatedly performing a number of processes on a semiconductor substrate such as a silicon wafer. For example, circuit patterns having electrical characteristics may be formed on the semiconductor substrate by performing fabrication processes, layer formation processes, photolithography processes, etching processes, ion implantation processes, cleaning processes, etc.

An electrical die sorting (EDS) process may be performed to inspect electrical characteristics of semiconductor devices on the semiconductor substrate.

Devices for performing the EDS process typically include a prober and a tester. The prober includes a probe card having a plurality of probe needles that can be electrically connected to the semiconductor devices on the semiconductor substrate. The tester can be electrically connected with the probe card. The prober is electrically connected to the tester by a plurality of pogo pins disposed through a pogo block, which is disposed between the prober and the tester, to protrude from upper and lower surfaces of the pogo block. The probe card is supported by a probe card stage, and the semiconductor substrate is supported by a substrate stage under the probe card.

While the probe card is electrically connected to the tester by the pogo pins, one of the semiconductor devices is electrically connected to the probe card by lifting up the substrate stage. Bump pads are disposed in the semiconductor devices, and the bump pads generally make contact with the probe needles as the substrate stage moves upwardly.

The bump pads may be marked with the probe needles during the EDS process. The probe marks formed in surface portions of the bump pads may be inspected by a probe mark inspection apparatus disposed adjacent to the prober. An example of a probe mark inspection apparatus is disclosed in Korean Patent Laid-Open Publication No. 2005-55041.

Referring to FIG. 1, a probe mark inspection apparatus 100 includes a stage 102 to support a semiconductor substrate 10, a light source 104 to illuminate an inspection region (such as a pad region in which bump pads are formed), and an image acquisition unit 106 to acquire an image on the inspection region. The light source 104 is disposed at one side of the image acquisition unit 106, providing a single inclined illumination onto the inspection region as shown in FIG. 1.

As the packing density of semiconductor devices has become highly integrated, the size of the bump pads and the diameter of the probe needles have become smaller. Thus, it has become more difficult to distinguish probe marks in an image that is obtained using single inclined illumination.

### SUMMARY OF THE INVENTION

According to embodiments of the present invention, an apparatus for inspecting a substrate includes a stage configured to support a substrate having an inspection region and an image acquisition unit configured to acquire an image of the inspection region to inspect the inspection region. An illumination unit is between the stage and the image acquisition unit and is configured to illuminate the inspection region. The illumination unit includes a printed circuit board having a ring-shaped inner surface facing toward the inspection region and a plurality of light-emitting elements circumferentially mounted on the ring-shaped inner surface.

In particular embodiments of the invention, each of the light-emitting elements may be a surface-mounting type light-emitting diode or a flip-chip type light-emitting diode.

In some embodiments of the present invention, the ring-shaped inner surface may have an inclination angle of about 40° to about 50° with respect to an upper surface of the stage.

For example, the ring-shaped inner surface may have an inclination angle of about 45° with respect to an upper surface of the stage.

In some embodiments of the present invention, a plurality of metal bumps may be disposed in the inspection region to electrically test a semiconductor device formed on the substrate.

In some embodiments of the present invention, the semiconductor device may include a display-driving circuit.

In some embodiments of the present invention, the printed circuit board may include a ring board having the ring-shaped inner surface and a supporting board extending horizontally outwardly from the ring board. A plurality of light-emitting elements may be circumferentially mounted on the ring-shaped inner surface of the printed circuit board.

In some embodiments of the present invention, the substrate inspection apparatus may further comprise a panel for supporting the ring illumination unit.

In some embodiments of the present invention, the panel may have a central hole corresponding to the ring board, and the ring illumination unit may be mounted on the panel so that an upper surface of the supporting board makes contact with a lower surface of the panel.

In some embodiments of the present invention, the panel may have a central hole corresponding to the ring board, and the ring illumination unit may be mounted on the panel so that an outer surface of the ring board and an upper surface of the supporting board make contact with an inner surface of the central hole and a lower surface of the panel, respectively.

In some embodiments of the present invention, the stage may be movably disposed between a first inspection position for electrically testing a semiconductor device formed on the substrate and a second inspection position under the ring illumination unit.

In some embodiments of the present invention, the substrate inspection apparatus may further include an image processing unit connected to the image acquisition unit for processing the image acquired by the image acquisition unit, an image storing unit connected to the image processing unit for storing image information, and a display unit connected to the image processing unit for displaying the image.

According to some embodiments of the invention, a ring illumination unit for inspecting a substrate includes a printed circuit board having a generally ring-shaped inner surface and a plurality of light-emitting elements circumferentially mounted on the ring-shaped inner surface.

According to some embodiments of the invention, a ring illumination unit for inspecting a substrate includes a generally ring-shaped inner surface, and a plurality of surface-mounting type light-emitting diodes and/or flip-chip type light-emitting diodes mounted on the ring-shaped inner surface.

According to some embodiments of the invention, an apparatus for inspecting a substrate having an inspection region includes a stage configured to support the substrate so that the inspection region is exposed. An image acquisition unit is configured to acquire an image of the inspection region. An illumination unit is between the stage and the image acquisition unit. The illumination unit includes a base having an opening therein with the opening having an inner surface, and a plurality of light-emitting elements mounted on the inner surface of the opening. The light-emitting elements are configured to illuminate the inspection region of the substrate. The inner surface is non-orthogonal with respect to the inspection surface.

### BRIEF DESCRIPTION OF THE DRAWINGS

FIG. 1 is a schematic view illustrating a conventional probe mark inspection apparatus;

FIG. 2 is a schematic view illustrating a substrate inspection apparatus with a ring illumination unit in accordance with embodiments of the present invention;

FIG. 3 is an enlarged cross-sectional view illustrating the ring illumination unit of FIG. 2;

FIG. 4 is a plan view illustrating a ring illumination unit of in FIG. 2;

FIG. 5 is a bottom view illustrating a ring illumination unit of FIG. 2;

FIGS. 6 and 7 are images of an inspection region acquired by a conventional substrate inspection apparatus; and

FIGS. 8 and 9 are images of an inspection region acquired by a substrate inspection apparatus in accordance with embodiments of the present invention.

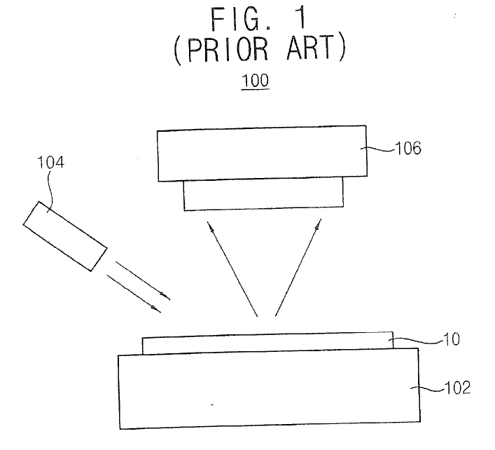

### DESCRIPTION OF THE EMBODIMENTS

Embodiments of the invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first thin film could be termed a second thin film, and, similarly, a second thin film could be termed a first thin film without departing from the teachings of the disclosure.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower,” can therefore, encompass both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations and/or schematic illustrations. As such, variations from the shapes of the illustrations as a result, for example, of manufacturing techniques and/or tolerances, are to be expected. Thus, embodiments of the present invention should not be construed as limited to the particular shapes illustrated herein but are to include deviations in shapes that may be modified by one of ordinary skill in the art or that may result, for example, from manufacturing processes. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of an element and are not intended to limit the scope of the present invention.

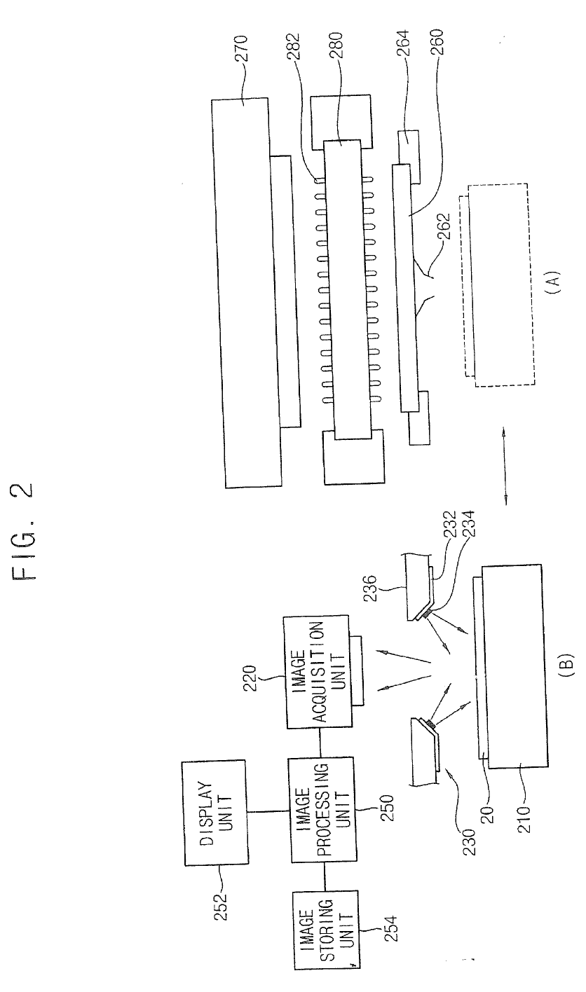

Referring to FIG. 2, the substrate inspection apparatus 200 may include a substrate stage 210 configured to support a substrate 20, an image acquisition unit 220 configured to acquire an image of an inspection region 22 (see FIG. 4) of the substrate 20, and a ring illumination unit 230 configured to illuminate the inspection region 22 of the substrate 20.

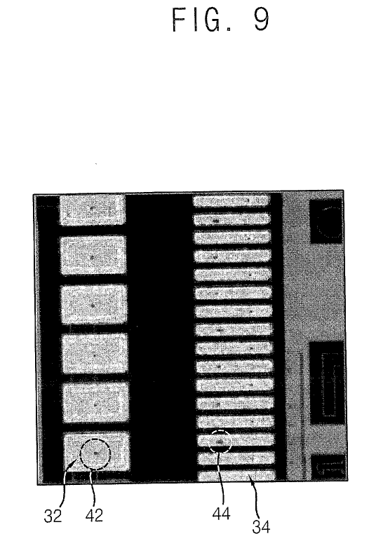

The substrate inspection apparatus 200 may be used to inspect probe marks 40, 42 and 44 (see FIGS. 8 and 9) formed at metal bump pads 30, 32 and 34 (see FIGS. 8 and 9) disposed in the inspection region 22 of the substrate 20 after performing an electrical testing process on the inspection region 22 (FIG. 4) of the substrate 20.

For example, after performing an electrical die sorting (EDS) process to electrically test a semiconductor device on a semiconductor substrate 20 (such as a silicon wafer), the substrate inspection apparatus 200 may be used for inspecting the probe marks 40, 42 and 44 that are formed at the metal bump pads 30, 32 and 34 of the semiconductor device, respectively. In particular embodiments of the present invention, display-driving integrated circuits may be formed on the semiconductor substrate 20, which may be connected to a flat panel display (FPD) such as a liquid crystal display (LCD), a plasma display panel (PDP), an organic electro luminescence display (OLED), etc., by using chip-on-film (CoF) technology. However, the spirit and scope of the present invention is not limited to display-driving integrated circuits, but embodiments of the present invention can be employed with various semiconductor devices.

The image acquisition unit 220 may include a charge-coupled device (CCD) camera. The image acquisition unit 220 may be connected with an image processing unit 250 to process the image of the inspection region 22. The image processing unit 250 may be connected with a display unit 252 and an image storing unit 254 for storing image data. The image of the inspection region 22 acquired by the image acquisition unit 250 may be displayed by the display unit 252.

The substrate stage 210 may be movably disposed between a first inspection position A where the electrical test process, e.g., an EDS process, is performed and a second inspection position B where the probe mark inspection process is performed. Further, the substrate stage 210 may be movably disposed in the vertical direction to adjust a height of the semiconductor substrate 20 with respect to the image acquisition unit 220 and/or probe card 260.

In particular, when the substrate 210 is placed at the first inspection position A, a probe card 260 may be disposed over the substrate stage 210. The probe card 260 may have probe needles 262 for probing the bump pads 30, 32 and 34 that are disposed in the inspection region 22 of the substrate 20. The probe card 260 may be supported by a probe card stage 264.

A tester 270 may be disposed over the probe card 260 to apply electrical signals to the semiconductor device through the probe needles 262 and the bump pads 30, 32 and 34, to inspect electrical characteristics of the semiconductor device. A pogo block 280 may be disposed between the tester 270 and the probe card 260 to electrically connect the probe card 260 to the tester 270. The pogo pins 282 may be mounted to the pogo block 280.

The EDS process may be performed at the first inspection position A by forming a contact between the probe needles 262 and the bump pads 30, 32 and 34 by lifting up the substrate stage 210.

The probe marks 40, 42 and 44 may be formed at surface portions of the bumps pads 30, 32 and 34 by making contact with the probe needles 262. After performing the EDS process, the probe mark inspection process may be performed at the second inspection position B using the image of the inspection region 22 acquired by the image acquisition unit 220.

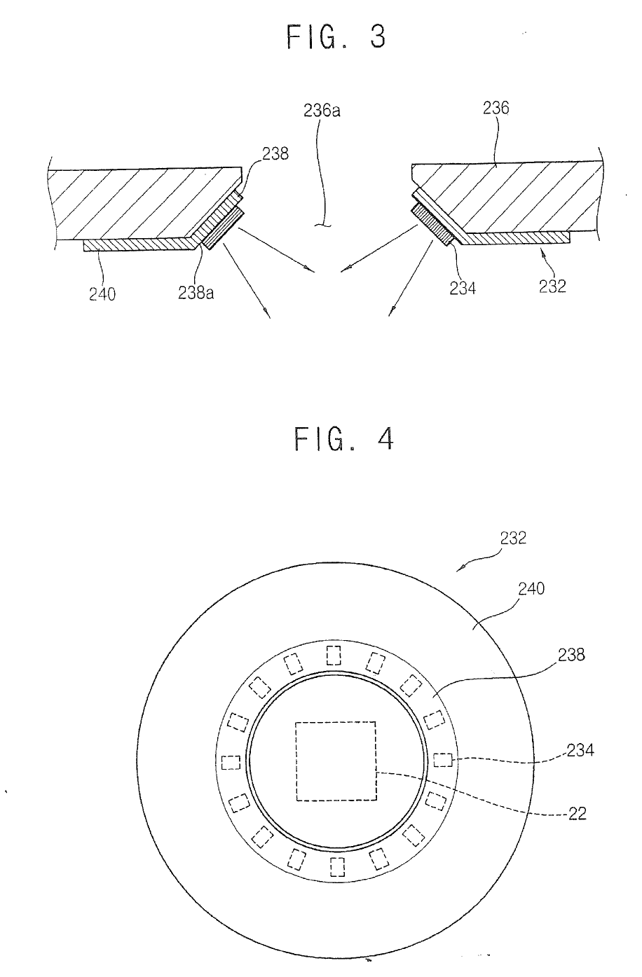

As shown in FIGS. 3 to 5, the ring illumination unit 230 may be disposed between the substrate stage 210 and the image acquisition unit 220 and may include a printed circuit board 232 and a plurality of light-emitting elements 234.

The printed circuit board 232 may include a ring board 238 having a ring shape and a supporting board 240 extending horizontally outwardly from a lower portion of the ring board 238. The ring board 238 may have a ring-shaped inner surface 238a facing toward the inspection region 22 of the substrate 20 and the plurality of light-emitting elements 234 may be circumferentially mounted on the ring-shaped inner surface 238a of the ring board 238.

The ring illumination unit 230 may further include a panel 236 horizontally disposed between the substrate stage 210 and the image acquisition unit 220. The printed circuit board 232 may be mounted on the panel 236.

The panel 236 may have a central hole 236a corresponding to the ring board 238. The 30 ring illumination unit 230 may be mounted on the panel 236 using fasteners, e.g., bolts, screws, rivets, etc., or adhesive members so that an outer surface of the ring board 238 and an upper surface of the supporting board 240 make contact with an inner surface of the central hole 236a and a lower surface of the panel 236, respectively.

The inner surface 238a of the ring board 238 may have an inclination angle of about 20° to about 70° or an inclination angle of about 40° to about 50° with respect to a horizontal surface, such as an upper surface of the substrate stage 210 on which the semiconductor substrate 20 is placed. For example, the inner surface 238a of the ring board 238 may have an inclination angle of about 45° with the upper surface of the substrate stage 210.

As shown in FIGS. 3 to 5, although the ring board 238 and the supporting board 240 have a circular ring shape, the spirit and scope of the present invention is not limited to the circular shape shown. As used herein, the term “ring” or “ring-shaped” includes various shapes that define an opening, such as circular or elliptical rings. Moreover, a “ring” or “ring-shaped” element can include shapes with linear sides, including pentagon, hexagon, or rectangular ring shapes.

Any suitable light emitting elements may be used for the light emitting elements 234. Examples of the light-emitting elements may include a surface-mounting type light-emitting diode or a flip-chip type light-emitting diode, which may improve light efficiency. A surface-mounting type light-emitting diode may include a light-emitting diode chip on an electrode that is mounted on a surface of a circuit board, such as a printed circuit board. A flip-chip type light-emitting diode may reverse a configuration of a surface-mount device by using a reflecting layer. Examples of surface-mounting type and/or flip-chip type light-emitting diodes are described in U.S. Pat. No. 6,614,058 to Lin et al. and U.S. Pat. No. 7,098,543 to Lai, the disclosures of which are hereby incorporated by reference in their entireties. Accordingly, in some embodiments, a surface-mounting type light-emitting diode or a flip-chip type light-emitting diode illuminates substantially only the inspection region 22 of the substrate 20, which may improve the light efficiency.

Any suitable number of light emitting elements 234 may be used. In particular embodiments, between about four or twenty light-emitting elements may be mounted on the inclined inner surface 238a of the ring board 238. In certain embodiments, sixteen light-emitting elements may be mounted on the inclined inner surface 238a of the ring board 238. However, the number of the light-emitting elements may be varied, for example, in accordance with the size of the inspection region 22 and/or the diameter of the ring board 238.

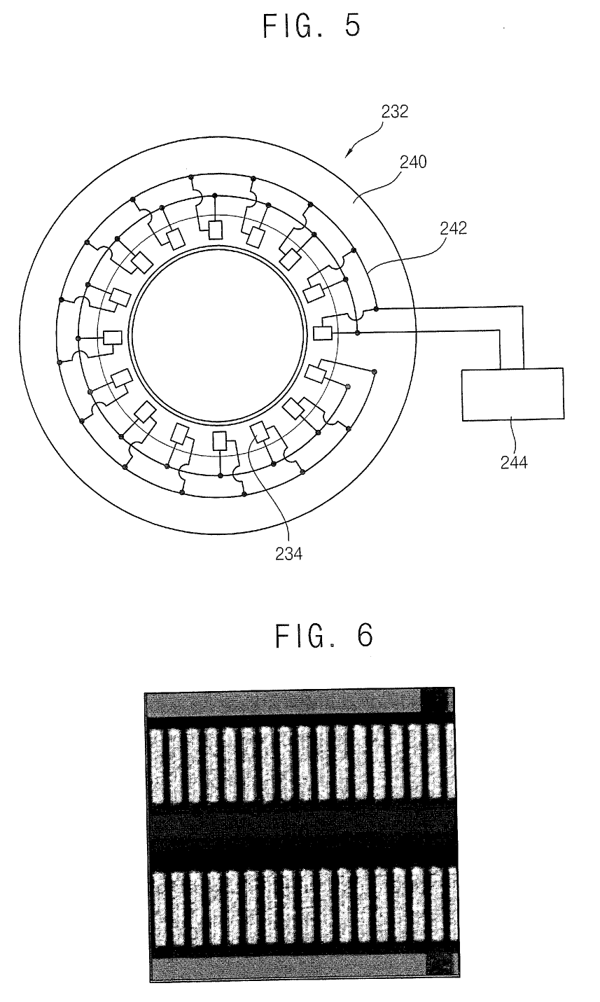

As shown in FIG. 5, the ring board 238 and the supporting board 240 may have wirings 242 that are electrically connected with the light-emitting elements. The wirings 242 may be provided to connect the light-emitting elements to an illumination controller 244.

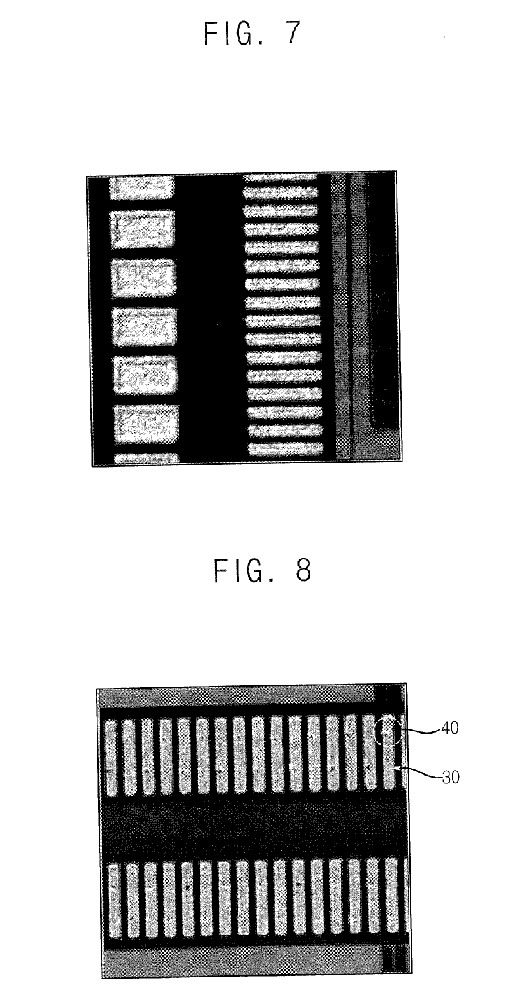

FIGS. 6 and 7 are images of an inspection region acquired by a conventional substrate inspection apparatus, and FIGS. 8 and 9 are images of an inspection region acquired by a substrate inspection apparatus in accordance with embodiments of the present invention.

When images of an inspection region are acquired using a conventional single inclined illumination, it may be difficult to distinguish probe marks in the images as shown in FIGS. 6 and 7. However, when images of the inspection region 22 are acquired using the ring illumination unit 230, the probe marks 30, 32 and 34 formed at the bump pads 40, 42 and 44 may be more easily distinguished in the images of the inspection region 22.

In accordance with the embodiments of the present invention as described above, the probe marks formed at the bump pads of the semiconductor substrate may be more easily distinguished in the image acquired using the ring illumination unit. Whether the probe needles have made normal contact with the bump pads during the EDS process may be ascertained using the acquired images. In addition, the light efficiency may be improved in the probe mark inspection process.

While the present invention has been particularly shown and described with reference to embodiments thereof, it will be understood by those of ordinary skill in the art that various changes in form and details may be made therein without departing from the spirit and scope of the present invention as defined by the following claims.

what is claimed is:

1. An apparatus for inspecting a substrate having an inspection region, the apparatus comprising:
a stage configured to support the substrate so that the inspection region is exposed;
an image acquisition unit configured to acquire an image of the inspection region; and
an illumination unit between the stage and the image acquisition unit, the illumination unit including a printed circuit board having an opening therein with the opening having an inner surface, and a plurality of light emitting elements mounted on the inner surface of the printed circuit board, wherein the light emitting elements are configured to illuminate the inspection region of the substrate.

2. The apparatus of claim 1, wherein each of the light-emitting elements is a surface-mounting type light-emitting diode or a flip-chip type light-emitting diode.

3. The apparatus of claim 1, wherein the inner surface has an inclination angle of about 40° to about 50° with respect to an upper surface of the stage.

4. The apparatus of claim 1, wherein a plurality of metal bumps is disposed in the inspection region to electrically test a semiconductor device formed on the substrate.

5. The apparatus of claim 4, wherein the semiconductor device includes a display-driving circuit.

6. The apparatus of claim 1, wherein the printed circuit board includes a ring board having a ring-shaped inner surface on which the light-emitting elements are mounted and a supporting board extending horizontally outwardly from the ring board.

7. The apparatus of claim 6, further comprising a panel configured to support the illumination unit.

8. The apparatus of claim 7, wherein the panel has a central hole corresponding to the ring board, and the illumination unit is mounted on the panel so that an upper surface of the supporting board makes contact with a lower surface of the panel.

9. The apparatus of claim 7, wherein the panel has a central hole corresponding to the ring board, and the illumination unit is mounted on the panel so that an outer surface of the ring board and an upper surface of the supporting board make contact with an inner surface of the central hole and a lower surface of the panel, respectively.

10. The apparatus of claim 1, wherein the stage is movably disposed between a first inspection position for electrically testing a semiconductor device formed on the substrate and a second inspection position under the illumination unit.

11. The apparatus of claim 1, further comprising:
an image processing unit connected to the image acquisition unit for processing the image acquired by the image acquisition unit;
an image storing unit connected to the image processing unit for storing image information; and
a display unit connected to the image processing unit for displaying the image.

12. The apparatus of claim 1, wherein the inner surface of the opening is ring-shaped.

13. An illumination unit for inspecting a substrate comprising:
a printed circuit board having a base with an opening therein, the opening having an inner surface and a plurality of light-emitting elements circumferentially mounted on the inner surface.

14. The illumination unit of claim 13, wherein each of the light-emitting elements is a surface-mounting type light-emitting diode or a flip-chip type light-emitting diode.

15. The illumination unit of claim 13, wherein the inner surface has an inclination angle of about 40° to about 50° with respect to a horizontal surface.

16. The illumination unit of claim 13, wherein the printed circuit board includes a ring board having a ring-shaped inner surface on which the light-emitting elements are mounted and a supporting board extending horizontally outwardly from the ring board.

17. The illumination unit of claim 13, wherein the inner surface is ring-shaped.

18. An illumination unit for inspecting a substrate comprising:
a base having an opening therein with the opening having an inner surface; and
a plurality of surface-mounting type light-emitting diodes and/or flip-chip type light-emitting diodes mounted on the inner surface.

19. The illumination unit of claim 18, wherein the plurality of surface-mounting type light-emitting diodes and/or flip-chip type light-emitting diodes are mounted on a printed circuit board on the inner surface.

20. The illumination unit of claim 19, wherein the printed circuit board includes a ring board having a ring-shaped inner surface on which the plurality of surface-mounting type light-emitting diodes and/or flip-chip type light-emitting diodes are mounted and a supporting board extending horizontally outwardly from the ring board.

21. The illumination unit of claim 18, wherein the inner surface has an inclination angle of about 40° to about 50° with respect to a horizontal surface.

22. The illumination unit of claim 18, wherein the inner surface of the opening is ring-shaped.

23. An apparatus for inspecting a substrate having an inspection region, the apparatus comprising:
a stage configured to support the substrate so that the inspection region is exposed;
an image acquisition unit configured to acquire an image of the inspection region;
an illumination unit between the stage and the image acquisition unit, the illumination unit including a base having an opening therein with the opening having an inner surface, and a plurality of light-emitting elements mounted on the inner surface of the opening wherein the light-emitting elements are configured to illuminate the inspection region of the substrate, wherein the inner surface is non-orthogonal with respect to the inspection region.

24. An apparatus of claim 23, wherein the opening is ring-shaped.

25. An apparatus of claim 23, wherein the inner surface has an inclination angle with respect to a surface of the stage in the range of about 20° to about 70°.

26. The apparatus of claim 23, wherein each of the light-emitting elements is a surface-mounting type light-emitting diode or a flip-chip type light-emitting diode.

27. The apparatus of claim 23, further comprising a printed circuit board mounted on the opening, wherein each of the light-emitting elements is mounted on the printed circuit board.
